(19) United States
(12) Patent Application Publication
(10) Pub. No.: US 2008/0261622 A1
(43) Pub. Date: Oct. 23, 2008

(54) Method and System for Determining Position of Mobile Communication Device Using Ratio Metric

(76) Inventors: Jeong Keun Lee, Seoul (KR); Tae Kyoung Kwon, Seoul (KR); Tae Il Kim, Seoul (KR); Tae Joon Ha, Kyunggi-do (KR); Hee Man Lee, Daejeon (KR)

Correspondence Address: NIXON & VANDERHYE, PC, 901 NORTH GLEBE ROAD, 11TH FLOOR, ARLINGTON, VA, 22203, US

(21) Appl. No.: 11/596,375

(22) PCT Filed: Jun. 16, 2006
(86) PCT No.: PCT/KR2006/002320

§ 371 Date: Nov. 14, 2006

(30) Foreign Application Priority Data
Aug. 17, 2005 (KR) 10-2005-0075178

(51) Int. Cl. H04Q 7/20

(52) U.S. Cl. 455/456.2

(57) ABSTRACT

A method of determining a location of a mobile communication terminal, the method including: receiving base station identification signals from a plurality of base stations; calculating distance ratios between the plurality of base stations and the mobile communication terminal, from the received base station identification signals; generating first variables and second variables from the distance ratios; and determining the location of the mobile communication terminal from the first variables and the second variables is provided.

### TECHNICAL FIELD

The present invention relates to a method and system for determining a location of a mobile communication terminal in a mobile communication network, and more particular, to a method and system for determining a location of a mobile communication terminal by using distance ratios between a plurality of base stations and the mobile communication terminal, which is calculated from signals received from the plurality of base stations.

### BACKGROUND ART

Various types of services, based on a location of a mobile communication terminal, are currently being developed. Specifically, when a user has the mobile communication terminal, the user may easily and conveniently acquire information associated with a current location of the mobile communication terminal. For example, services, such as traffic information informing about traffic status, neighboring area information, tour information, and the like, may be provided to the user. Also, a physical distribution management service (e.g., a freight and vehicle tracing service), or a mobile commerce for local products, souvenir shopping, ticket purchasing, and the like, may be based on the location of the mobile communication terminal.

As shown in FIG. 1, a terminal, which is moving in a mobile communication network, communicates with a plurality of base stations, for example, BS1, BS2, and BS3, while transceiving unique identification information. Various types of technologies and studies have been made to determine a location X (x, y, z) of the mobile communication terminal from the plurality of base stations, for example, BS1, BS2, and BS3.

Examples of a handset-based positioning technology include Qualcomm/SnapTrack Corporation's assisted-global positioning system (A-GPS) technology, American Surf Corporation's A-GPS technology, British Cambridge Positioning System (CPS) Corporation's Enhanced Observed Time Difference (E-OTD) technology, and the like. However, the handset-based positioning technology requires additional hardware and software to be installed in the terminal, which may increase manufacturing costs of the terminal. Also, the handset-based positioning is an expensive solution which requires a Position Determination Entity (PDE), which is an additional network element to help with positioning of the terminal. However, the handset-based positioning technology does not support both an existing terminal and a newly released terminal which is not provided with new hardware. In other words, the handset-based positioning technology supports only a special purpose terminal. Also, in the case of the E-OTD technology based on the Group Special Mobile (GSM) standard, the E-OTD technology may not be applicable to the portable Internet. Thus, the development of a completely new technology is required to apply the E-OTD technology to the portable Internet.

Examples of a network-based positioning technology include Qualcomm/SnapTrack Corporation's Advanced Forward Link Trialateration (AFLT) technology, Trueposition Corporation's U-Time Difference of Arrival (TDOA) using a time difference or a phase difference between signals which are received from a plurality of base stations, and the like. The network-based positioning technology determines a location of a terminal using wireless network data. Thus, the network-based positioning technology adds hardware and software to a wireless network while not adding hardware to the terminal, and reducing modifications of the terminal. Depending upon circumstances, a PDE may be required. Since the network-based positioning technology requires an addition of positioning hardware to all access network elements, a network provider may need to invest a great amount of money. Also, even after constructing the network-based positioning technology, continuous investments and maintenances are required according to changes and advancements of the wireless network.

Also, a triangulation method of changing a received signal strength (RSS) from the plurality of base stations, for example, BS1, BS2, and BS3, into a distance has been developed to determine the location X(x, y, z) of the mobile communication terminal. However, since the RSS is very sensitive and unstable from a surrounding environment, the triangulation method is very inaccurate, and thus, is not suitable for the mobile communication network.

Also, a database pattern matching technology determines a current location of a mobile communication terminal by creating a database with respect to signal values, which are received from a plurality of base stations, for each location, and comparing the signal values with a measured signal value. However, in the case of the database pattern matching technology, it is required to make a database with respect to signal values in a great number of locations. Also, every time a location of a base station, a direction, a location of neighboring buildings, and the like, are changed, the database must be updated to reflect the change. Thus, a great amount of costs may be spent for constructing, maintaining, and managing the database.

As described above, the positioning technologies for improving a performance are mostly associated with hardware solutions, and hardware access methods require a great amount of costs. Thus, domestic and foreign mobile communication providers may not employ hardware access methods for commercialized products. Also, the conventional technologies are very inaccurate under poor surroundings, for example, indoors or in a shadowing area, and solutions for overcoming the disadvantages require a great amount of additional costs and system modifications.

Although an attempt is being made to determine the location of the mobile communication terminal based on software, it is so far only a simple mathematical algorithm. Also, since various types of substantial features of the mobile communication network are not considered, the above method is inaccurate, and thus not commercialized. Also, while a positioning performance is required to be updated according to a worldwide mobile communication network environment, updating the positioning performance has been not effectively performed.

### DISCLOSURE OF INVENTION

### Technical Goals

The present invention provides a method of determining a location of a mobile communication terminal from distance ratios between a plurality of base stations and the mobile communication terminal, so as to accurately determine the location of the mobile communication terminal even when unstable signals are received from the plurality of base stations in a mobile communication network.

The present invention also provides a system for implementing the method of determining the location of the mobile communication terminal.

### Technical Solutions

According to an aspect of the present invention, there is provided a method of determining a location of a mobile communication terminal, the method including: receiving predetermined base station identification signals from a plurality of base stations; calculating distance ratios between the plurality of base stations and the mobile communication terminal, from the received base station identification signals; generating first variables and second variables from the distance ratios; and determining the location of the mobile communication terminal from the first variables and the second variables.

In this instance, the method of determining a location of a mobile communication terminal may further include: determine a center of the plurality of base stations from the received base station identification signals; and extract location values of virtual base stations from which a base station identification signal is not received within a predetermined radius from the determined center, wherein the location values of the virtual base stations may be utilized for determining the location of the mobile communication terminal.

According to another aspect of the present invention, there is provided a method of determining a location of a mobile communication terminal, the method including: receiving predetermined signals from a plurality of base stations; calculating weights based on a distance between each of the plurality of base stations and the mobile communication terminal, from the received signals; and determining the location of the mobile communication terminal from the weights and location values of the plurality of base stations.

According to still another aspect of the present invention, there is provided a system for determining a location of a mobile communication terminal, the system including: a distance ratio calculation unit calculating distance ratios between a plurality of base stations and the mobile communication terminal, from base station identification signals which are received from the plurality of base stations; a locus calculation unit generating first variables and second variables from the distance ratios; and a location determination unit determining the location of the mobile communication terminal from the first variables and the second variables.

In this instance, the system for determining the location of the mobile communication terminal may further include: a virtual base station selection unit determining a center of the plurality of base stations from the received base station identification signals, and extracting location values of virtual base stations from which a base station signal is not received within a predetermined radius from the determined center, wherein the location determination unit may utilize the location values of the virtual base stations for determining the location of the mobile communication terminal.

According to yet another aspect of the present invention, there is provided a system for determining a location of a mobile communication terminal, the system including: a weight calculation unit calculating weights based on a distance between each of a plurality of base stations and the mobile communication terminal, from base station identification signals which are received from the plurality of base stations; and a location determination unit determining the location of the mobile communication terminal from the weights and locations values of the plurality of base stations.

### BRIEF DESCRIPTION OF DRAWINGS

FIG. 1 is a diagram illustrating a general relation between a plurality of base stations and a mobile communication terminal in a mobile communication network;

FIG. 2 is a diagram illustrating a method of calculating a distance ratio according to an exemplary embodiment of the present invention;

FIG. 3 is a flowchart illustrating a method of determining a location of a mobile communication terminal according to an exemplary embodiment of the present invention;

FIG. 4 is a diagram illustrating a relation between locations of two base stations and an Apollonius circle;

FIG. 5 is a block diagram illustrating a system for determining a location of a mobile communication terminal, which embodies the method of FIG. 3;

FIG. 6 is a flowchart illustrating a method of determining a location of a mobile communication terminal according to another exemplary embodiment of the present invention;

FIG. 7 is a block diagram illustrating a system for determining a location of a mobile communication terminal, which embodies the method of FIG. 6;

FIG. 8 is a flowchart illustrating a method of determining a location of a mobile communication terminal according to still another exemplary embodiment of the present invention;

FIG. 9 is a diagram illustrating a location relation between a mobile communication terminal and a virtual base station;

FIG. 10 is a block diagram illustrating a system for determining a location of a mobile communication terminal, which embodies the method of FIG. 8;

FIG. 11 is a diagram illustrating an example of determining a location of a mobile communication terminal in a server, which is connected to a network, according to an exemplary embodiment of the present invention; and

FIG. 12 is a diagram illustrating an example of determining a location of a mobile communication terminal using an upstream method according to an exemplary embodiment of the present invention.

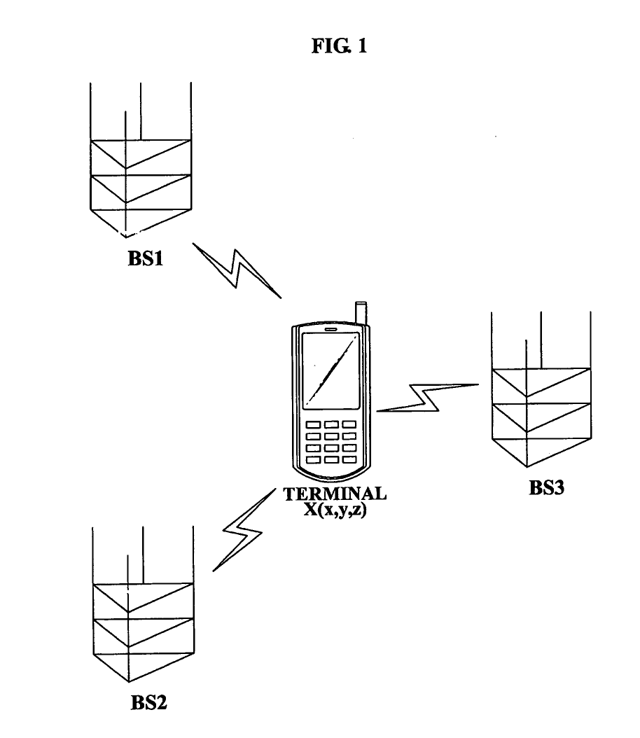

### BEST MODE FOR CARRYING OUT THE INVENTION

Reference will now be made in detail to exemplary embodiments of the present invention, examples of which are illustrated in the accompanying drawings, wherein like reference numerals refer to the like elements throughout. The exemplary embodiments are described below in order to explain the present invention by referring to the figures.

Base stations may communicate with a moving mobile communication terminal, while transceiving unique identification information and predetermined data, such as text data, speech data, and the like. When the mobile communication terminal is in a standby mode of not performing a call, a message transmission, an Internet access, and the like, the base stations may check a current status of the mobile communication terminal while transceiving a base station identification signal with the mobile communication terminal.

Hereinafter, a method of calculating distance ratios between two base stations and the mobile communication terminal will be described.

When expressing the strength or power P_{RX} of a signal, which the mobile communication terminal receives from any one of the base stations in the mobile communication network, in a decibel (dB) scale, it may be reduced to equation 1 below. In equation 1, P_{TX} designates power of a sending signal which is transmitted from a pilot channel of the base station, and Pₚₐₜₕₗₒₛₛ designates power which is lost during a process of transferring the sending signal from the base station to the mobile communication terminal.

P_{RX}=P_{TX}−Pₚₐₜₕₗₒₛₛ [Equation 1]

Here, the lost power Pₚₐₜₕₗₒₛₛ may be represented as equation 2. In equation 2, d designates a distance between the base station and the mobile communication terminal, and n designates a pathloss exponent which indicates a loss degree according to the distance.

Pₚₐₜₕₗₒₛₛ=10n log₁₀(d)+X_{shadowing} [Equation 2]

In equation 2, n has a value between 2 and 4. For example, n may have a value of about 4 in a downtown area, and may have a value of about 2.5 to about 3 in the suburbs or on the outskirts. When the mobile communication terminal receives a signal from the base station, a degradation of the received signal is not determined by only the distance d between the base station and the mobile communication. Also, the degradation of the received signal is greatly affected by the environment alongside the propagation path where the signal goes through, for example, obstacles, shadowing areas, signal reflection, signal diffraction, and the like. In this case, the loss power by an environmental effect, for example, a shadowing effect, was expressed as X_{shadowing} in equation 2. Also, it is known that the loss power X_{shadowing} includes a log normal distribution which has a constant deviation based on the mean, 0. Hereinafter, it is assumed that the loss power X_{shadowing} is disregarded.

When the loss power X_{shadowing} is disregarded, the distance d between the base station and the mobile communication terminal may be represented as,

d=10^{(P}^{_{TX}}^{-P}^{_{RX}}^{)/(10n)} [Equation 3]

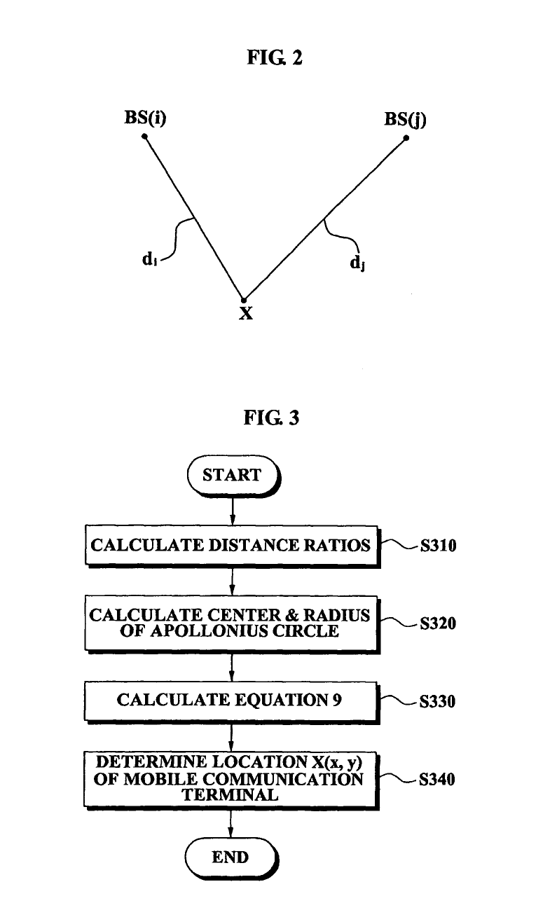

Accordingly, the power P_{TX} of the sending signal from the base station must be known to accurately calculate the distance d from the power P_{RX} of the signal which is received from the base station. In the present invention, it is assumed that the powers of signals, which are transmitted from pilot channels of base stations, are all same. In this instance, a distance ratio dⱼ/dᵢ from two different base stations BS(i) and BS(j) to a location X (x, y) of the mobile communication terminal, as shown in FIG. 2, may be represented as equation 4, from powers P_{RXi} and P_{RXj} of the signals which are received from the base stations. The distance ratio dⱼ/dᵢ is calculated based on the power difference between two signals which are received from two base stations.

$$\frac{{d}_{j}}{{d}_{i}} = {10}^{( {P}_{{TX}_{i}} - {P}_{{RX}_{j}} ) / ( 10 n )} \qquad [ Equation 4 ]$$

FIG. 3 is a flowchart illustrating a nonlinear least squares method of determining a location of a mobile communication terminal by using a distance ratio calculation as described according to an exemplary embodiment of the present invention.

In operation S310, distance ratios dₗ/dᵢ between base stations and the mobile communication terminal are calculated by equation 4, to determine the location of the mobile communication terminal by using the nonlinear least squares method according to the present exemplary embodiment. Here, dₗ designates a distance from a location (xₗ, yₗ) of a first base station, among an n number of base stations in a mobile communication network, to the location X(x, y) of the mobile communication terminal. Also, dᵢ designates a distance from a location (xᵢ, yᵢ) of each of remaining base stations, except the first base station, to the location X(x, y) of the mobile communication terminal. Specifically, the calculated distance ratios dₗ/dᵢ correspond to ratios which are acquired by comparing the distance dₗ between the first base station and the mobile communication terminal with the distances dᵢ between the n number of base stations and the mobile communication terminal.

When the distance ratios dₗ/dᵢ are calculated, a locus X(x, y) of points where the mobile communication terminal may be located on Apollonius circles, which use the distance ratios dₗ/dᵢ as variables, may be represented as equation 5 below. Here, c designates a square of each of the distance ratios dₗ/dᵢ as shown in equation 6. Also, when a distance ratio, for example, dₗ/dᵢ, between two points on a two-dimensional plane is given, the Apollonius circle designates the locus of the points which satisfies the distance ratio.

(x−xl)²+(y−yl)²=cᵢ(x−xi)²+cᵢ(y−yi)² [Equation 5]

$${c}_{i} = {( \frac{{d}_{1}}{{d}_{j}} )}^{2} \qquad [ Equation 6 ]$$

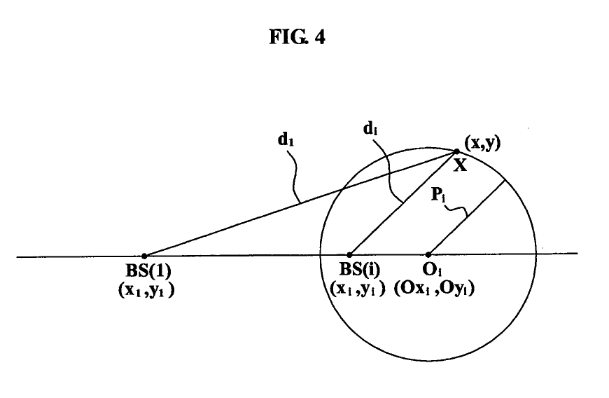

Equation 5 may be arranged to equation 7 below. In operation S320, a circle of the Apollonius circle may be calculated by equation 7. As shown in FIG. 4, in equation 7, Oᵢ(Oxi, Oyi)=((cᵢxi−xl)/(cᵢ−1), (cᵢyi−yl)/(cᵢ−1)) designates the center of the Apollonius circle which is generated by the ratio of the distance dₗ between the location (xₗ, yₗ) of the first base station and the location X(x, y) of the mobile communication terminal to the distance dᵢ between the location (xᵢ, yᵢ) of each of other base stations and the location X(x, y) of the mobile communication terminal. Also, in operation S320, a radius Pi of the Apollonius circle may be calculated by equation 8. In this case, it is assumed that the location (xᵢ, yᵢ) of each of other base stations may be pre-calculated since the base stations communicate with the mobile communication terminal while transceiving unique identification information.

(x−Oxi)²+(y−Oyi)²=Pi² [Equation 7]

$$Pi = \sqrt{\frac{{c}_{i} ( {( x 1 - xi )}^{2} + {( y 1 - yi )}^{2} )}{{( {c}_{i} - 1 )}^{2}}} \qquad [ Equation 8 ]$$

When an error including an environmental effect, for example, a shadowing effect, is not included in signals which are received from the n number of base stations, only an n−1 number of distance ratio combinations are independent from a total of an n(n−1)/2 number of distance ratio combinations. With the assumption that n>=4, all Apollonius circles meet each other at a single point. The single point becomes the location of the mobile communication terminal on the two-dimensional plane. In this case, since the environmental effect may not be completely disregarded, the Apollonius circles do not meet at the single point and thus, greater than the n−1 number of distance ratio combinations may be utilized. However, no great difference was found in accuracy between using only the n−1 number of distance ratio combinations, and using the distance ratio combinations greater than the n−1 number, but complexity was increased when using the distance ratio combinations greater than the n−1 number. Thus, as shown in equation 6, only the n−1 number of ratios between the distance dₗ from the first base station, and the distance dᵢ of each of other base stations may be utilized.

In operations S330 and S340, the location X(x, y) of the mobile communication terminal may be determined by calculating a nonlinear least squares method as shown in equation 9 below. Here, |X−Oᵢ| designates a distance between two location coordinates. Also, an argument of finding X(x, y) where Σ term becomes a minimal value may be calculated by a nonlinear optimizing method, such as Newton's method, and the like.

$$X ( x , y ) = {arg min}_{X} {{Q}_{i = 1}}^{n - 1} \frac{( {\vert X - {O}_{i} \vert}^{2} - {P}_{i}^{2} )}{{P}_{i}^{2}} \qquad [ Equation 9 ]$$

Specifically, a location where a sum of |X−Oᵢ|²−Pi² becomes a minimal value is acquired. Here, |X−Oᵢ|²−Pi² designates a difference between square of distances |X−Oᵢ|² from the centers Oᵢ(Oxi, Oyi) of the Apollonius circles to the location X(x, y) of the mobile communication terminal, and square of radiuses Pi² of the Apollonius circles. In equation 9, |X−Oᵢ|²−Pi² is divided by Pi² since the location X(x, y) of the mobile communication terminal may be greatly affected due to a measurement error of distance ratio when the radius of the Apollonius circle is comparatively great. In other words, when the radius of the Apollonius circle is comparatively great, a value of |X−Oᵢ|²−Pi² is divided using Pi² as a denominator to prevent an unnecessary increase of a proportion, which makes a contribution to Σ term of the entire objective function for reducing the value of a numerator |X−Oᵢ|²−Pi².

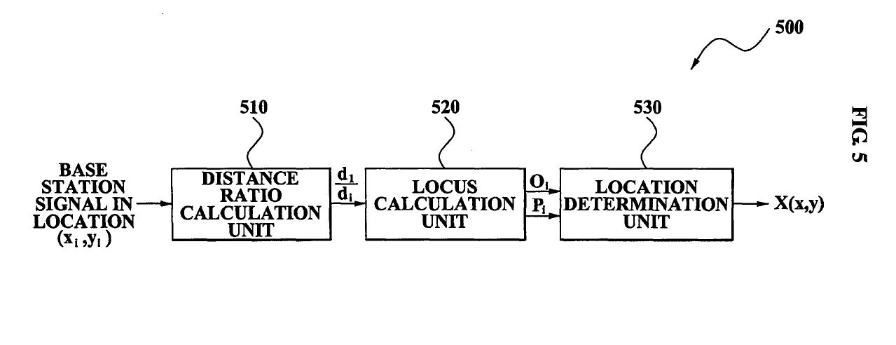

FIG. 5 illustrates a block diagram of a location determination system 500 of a mobile communication terminal according to an exemplary embodiment of the present invention. Here, the location of the mobile communication terminal is determined by using a distance ratio calculation from base stations according to the nonlinear least squares method of FIG. 3. Referring to FIG. 5, the location determination system 500 includes a distance ratio calculation unit 510, a locus calculation unit 520, and a location determination unit 530.

The distance ratio calculation unit 510 receives predetermined signals from an n(i=1˜n) number of base stations which are located in (xᵢ, yᵢ). Also, the distance ratio calculation unit 510 calculates the distance ratios dₗ/dᵢ between the base stations and the mobile communication terminal, from the received signals (see operation S310 of FIG. 3).

When the distance ratio calculation unit 510 calculates the distance ratios dₗ/dᵢ, the locus calculation unit 520 calculates the centers Oᵢ(Oxi, Oyi) of the Apollonius circles (see equation 7) and the radiuses Pi of the Apollonius circles, from the distance ratios dₗ/dᵢ. The Apollonius circle designates the locus X(x, y) of points where the mobile communication terminal may be located (see operation S320 of FIG. 3). Here, the centers of the Apollonius circles correspond to Oᵢ(Oxi, Oyi)=((cᵢxi−xl)/(cᵢ−1), (cᵢyi−yl)/(cᵢ−1)), and the radiuses may be calculated in the same method as equation 8.

Accordingly, the location determination unit 530 calculates the nonlinear least squares method according to equation 9, from the centers Oᵢ(Oxi, Oyi) of the Apollonius circles (see equation 7) and the radiuses Pi of the Apollonius circles and thus, determines the location X(x, y) of the mobile communication terminal (see operations S330 and S340 of FIG. 3). Also, the location determination unit 530 calculates the argument of finding X(x, y) where the E term of equation 9 becomes a minimal value, to determine the location where the sum of |X−Oᵢ|²−Pi² becomes a minimal value as the location of the mobile communication terminal. Here, |X−Oᵢ|²−Pi² designates a difference between square of distances |X−Oᵢ|² from the centers Oᵢ(Oxi, Oyi) of the Apollonius circles to the location X(x, y) of the mobile communication terminal, and square of radiuses Pi² of the Apollonius circles.

Hereinafter, a weighted centroid method will be described. The weighted centroid method can reduce the above-described calculation complexity of the nonlinear optimizing method, and also can accurately determine the location of the mobile communication terminal in a similar method as the nonlinear optimizing method.

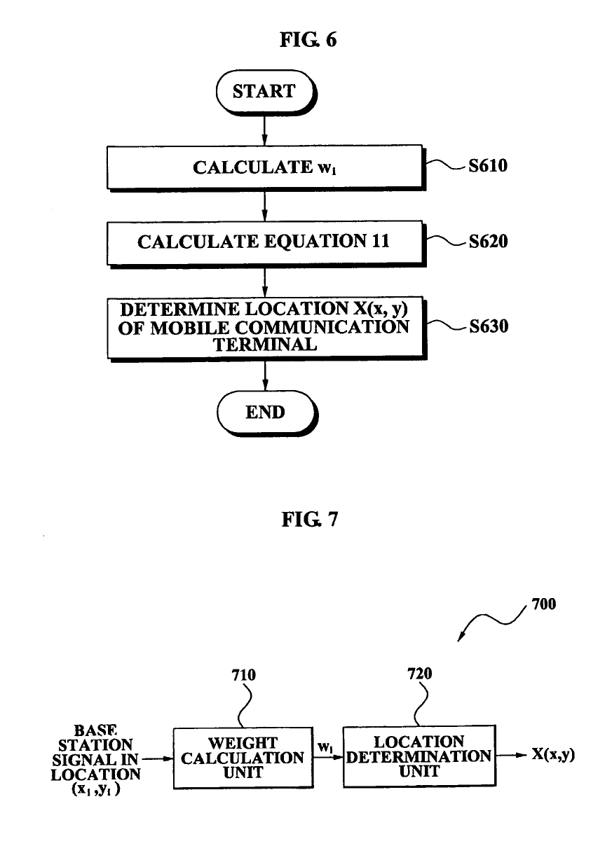

FIG. 6 is a flowchart illustrating the weighted centroid method of determining a location of a mobile communication terminal by using the distance ratios dₗ/dᵢ between base stations and the mobile communication terminal according to another exemplary embodiment of the present invention.

In operation S610, weights wᵢ are calculated by equation 10, to determine the location of the mobile communication terminal by using the weighted centroid method according to the present exemplary embodiment. Here, each of the weights wᵢ designates an inverse of the distance between each of the n number of base stations and the mobile communication terminal.

$${w}_{i} = \frac{1}{{d}_{i}} \qquad [ Equation 10 ]$$

Also, instead of using the inverse of the distance from each base station, the distance ratios dₗ/dᵢ between the base stations and the mobile communication terminal may be utilized as the weights wᵢ according to the calculation method as shown in equation 4. Specifically, the distance ratios dₗ/dᵢ, which are acquired by comparing the distance dᵢ between a predetermined base station and the mobile communication terminal with the distances dₗ between the plurality of base stations and the mobile communication terminal, may be utilized as the weights wᵢ.

Accordingly, in operations S620 and S630, as shown in equation 11 below, the location X(x, y) of the mobile communication terminal may be determined as a value which is acquired by multiplying location Si(xi, yi) of each base station with the weights wᵢ, adding the results of the multiplications and dividing the results of the additions by a sum of the weights wᵢ. Here, even when utilizing the distance ratios dₗ/dᵢ between the base stations and the mobile communication terminal as the weights wᵢ, the same result may be acquired.

$$X ( x , y ) = \frac{{{Q}_{i = 1}}^{n} {w}_{i} {ES}_{i}}{{{Q}_{i = 1}}^{n} {w}_{i}} \qquad [ Equation 11 ]$$

The weighted centroid method, as described above, has a constraint in that the location X(x, y) of the mobile communication terminal is determined as a convex hull, i.e. a value of a minimal size of an inner polygon which covers all the locations of the n number of base stations. However, in a general urban environment, the weighted centroid method generally shows a similar accuracy as the nonlinear optimizing method.

FIG. 7 illustrates a block diagram of a location determination system 700 of a mobile communication terminal according to another exemplary embodiment of the present invention. Here, the location of the mobile communication terminal is determined by using a distance ratio calculation from base stations according to the weighted centroid method of FIG. 6. Referring to FIG. 7, the location determination system 700 includes a weight calculation unit 710 and a location determination unit 720.

The weight calculation unit 710 receives predetermined signals from an n(i=1˜n) number of base stations which are located in (xi, yi). Also, as shown in equation 10, the weight calculation unit 710 calculates the weights based on distances between the base stations and the mobile communication terminal, from the received signals (see operation S610 of FIG. 6). As described above, the inverse of the distances between the base stations and the mobile communication terminal according to equation 10 may be utilized as the weights wᵢ. Also, the distance ratios dₗ/dᵢ which are acquired by comparing the distance dₗ between a predetermined base station and the mobile communication terminal with the distances dᵢ between the plurality of base stations and the mobile communication terminal, may be utilized as the weights wᵢ.

When the weight calculation unit 710 calculates the weights wᵢ, the location determination unit 720 calculates a weighted centroid question according to equation II, and determines the location of the mobile communication terminal from the location values Si(xi, yi) of the plurality of base stations and the weights wᵢ (see operations S620 and S630 of FIG. 6). Also, the location determination unit 720 multiplies the location Si(xi, yi) of each base station with the weights wᵢ, adds up the results of the multiplications, and divides the results of the additions by the sum of the weights wᵢ, to determine the mean of the location values Si(xi, yi) of the base stations based on the weights wᵢ, as the location of the mobile communication terminal.

When the calculated location of the mobile communication terminal according to the nonlinear optimizing method of FIG. 3 is near to a base station from which a signal is not received, the calculated location of the mobile communication terminal may be an incorrectly calculated location since a measurement value of a signal strength is greatly affected by a neighboring environment. This is because the distance ratio with the base station from which the signal is not received is not reflected. Thus, a method of selecting a virtual base station according to still another exemplary embodiment of the present invention is suggested to remove an error as described above.

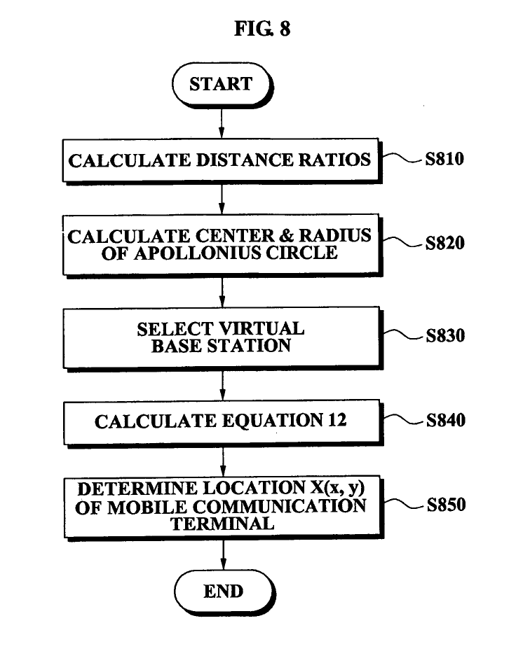

FIG. 8 is a flowchart illustrating a method of selecting a virtual base station according to still another embodiment of the present invention. Here, the location of the mobile communication terminal is determined by using the distance ratios dₗ/dᵢ between the base stations and the mobile communication terminal, in the same method as the nonlinear optimizing method which has been described with FIG. 3.

In operation S810, the distance ratios dₗ/dᵢ between the base stations and the mobile communication terminal are calculated by equation 4, to determine the location of the mobile communication terminal by using a virtual base station selection method according to the present exemplary embodiment. As described with FIG. 3, when the distance ratios dₗ/dᵢ are calculated, the center Oᵢ(Oxi, Oyi) of the Apollonius circle is calculated according to equation 7. Here, the Apollonius circle is generated by the ratio of the distance dₗ between the location (xi, yi) of the first base station and the location X(x, y) of the mobile communication terminal, to the distance dᵢ between the location (xᵢ, yᵢ) of each of the other base stations and the location X(x, y) of the mobile communication terminal. Also, in operation S820, the radius Pi of the Apollonius circle is calculated by equation 8.

In operation S830, a center BS0 of the locations of the base stations from which the mobile communication terminal received the signals is determined. Also, a location value Vⱼ (e.g., a two-dimensional vector) of virtual base stations which are located within a predetermined distance 910 from the determined center BS0, but from which the mobile communication terminal did not receive a signal is extracted. In a subsequent calculation, the calculated location of the mobile communication terminal is not included in a predetermined threshold distance value Dth from the location Vⱼ of the virtual base station.

For this, an internal Σ term of equation 9 for acquiring a minimization argument according to the nonlinear optimizing method of FIG. 3 is modified. Specifically, in operations S840 and S850, the location X(x, y) of the mobile communication terminal may be determined by using equation 12. Here, SCALE designates a coefficient, and m designates a number of the selected virtual base stations. In equation 12, when a distance between the location X(x, y) of the mobile communication terminal and the location Vⱼ of the virtual base station is less than the threshold value Dth (i.e. when the location X(x, y) of the mobile communication terminal is near to the virtual base station), a value of an argument objective function increases. Thus, the location Vⱼ of the virtual base station is not reflected. Specifically, in an added equation (a sigmoid function) of equation 12, when a distance |X−Vⱼ| between the mobile communication terminal and the virtual base station is greater than the threshold value Dth, the sigmoid function approaches 0, and decreases the objective function. Thus, the location of the virtual base station is reflected in the location determination. Conversely, when the distance |X−Vⱼ| between the mobile communication terminal and the virtual base station is less than the threshold value Dth, the sigmoid function sharply increases according to a predetermined coefficient SCALE value, and increases the objective function. Thus, the location of the virtual base station is not reflected in the location determination.

$$X ( x , y ) = {arg min}_{X} \{ \begin{matrix}{{Q}_{i = 1}}^{n - 1} \frac{( {\vert X - {O}_{i} \vert}^{2} - {P}_{i}^{2} )}{{P}_{i}^{2}} + \\ {{Q}_{j = 1}}^{m} \frac{SCALE}{( 1 + exp ( \vert X - {V}_{j} \vert - {D}_{th} ) )}\end{matrix} \} \qquad [ Equation 12 ]$$

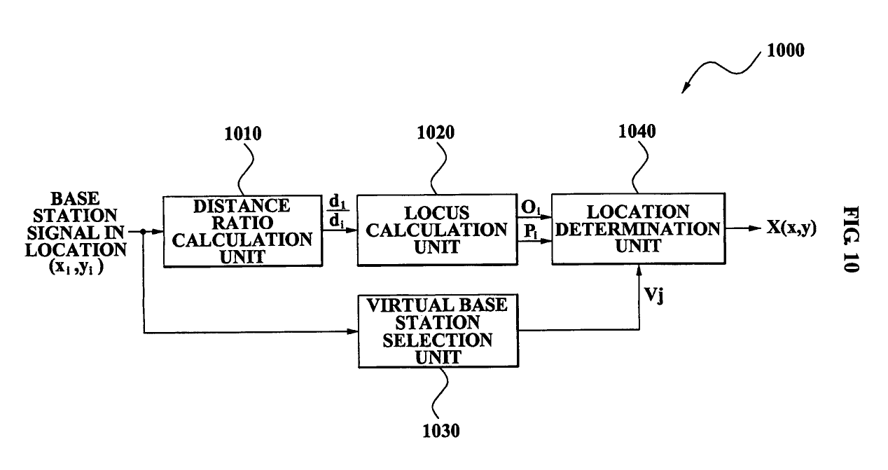

FIG. 10 illustrates a block diagram of a location determination system 1000 of a mobile communication terminal according to still another embodiment of the present invention. Here, the location of the mobile communication terminal is determined by using a distance ratio calculation from base stations according to the virtual base station selection method of FIG. 8. Referring to FIG. 10, the location determination system 1000 includes a distance ratio calculation unit 1010, a locus calculation unit 1020, a virtual base station selection unit 1030, and a location determination unit 1040. Since the distance ratio calculation unit 1010 and the locus calculation unit 1020 operate in a method that is the same as the distance ratio calculation unit 510 and the locus calculation unit 520 of FIG. 5, description related thereto will be briefly described.

The distance ratio calculation unit 1010 receives predetermined signals from an n(i=1˜n) number of base stations which are located in (xi, yi). Also, the distance ratio calculation unit 1010 calculates the distance ratios dₗ/dᵢ between the base stations and the mobile communication terminal (see operation S810 of FIG. 8).

When the distance ratio calculation unit 1010 calculates the distance ratios dₗ/dᵢ, the locus calculation unit 1020 calculates the centers Oᵢ(Oxi, Oyi) of the Apollonius circles (see equation 7) and the radiuses Pi of the Apollonius circles (see operation S820 of FIG. 8), from the distance ratios dₗ/dᵢ. Here, the centers of the Apollonius circles correspond to Oᵢ(Oxi, Oyi)=((cᵢxi−xl)/(cᵢ−1), (cᵢyi−yl)/(cᵢ−1)), and the radiuses may be calculated in the same method as equation 8.

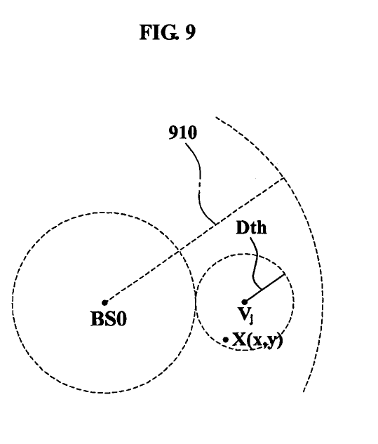

The virtual base station selection unit 1030 determines the center BS0 of the base stations from which the mobile communication terminal received the signals. Also, as shown in FIG. 9, the virtual base station selection unit 1030 extracts location values Vⱼ of the virtual base stations from which a base station signal is not received within the radius 910 from the determined center BS0.

Accordingly, the location determination unit 1040 calculates the minimization argument according to equation 12, from the location values Vⱼ of the virtual base stations, the centers Oᵢ(Oxi, Oyi) of the Apollonius circles (see equation 7) and the radiuses Pi of the Apollonius circles and thus, determines the location X(x, y) of the mobile communication terminal (see operations S840 and S850 of FIG. 8). In this instance, the location determination unit 1040 determines the location of the mobile communication terminal so that distances between the mobile communication terminal and the virtual base stations may not be less than the threshold value Dth.

As described above, the location determination systems 500, 700, and 1000 according to exemplary embodiments of the present invention may be installed in the mobile communication terminal. Also, a user, who has the mobile communication terminal installed with the location determination system 500, 700, or 1000, may utilize various types of services based on the location of the mobile communication terminal, even when the user is moving.

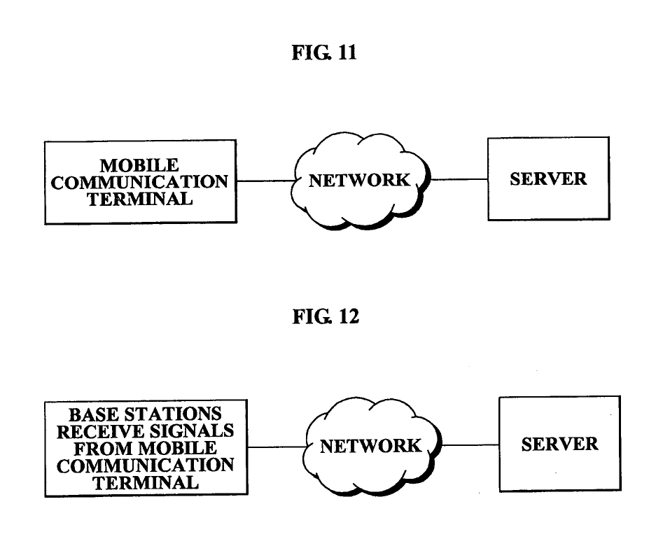

As shown in FIG. 11, the location determination system 500, 700, or 1000 may be installed in a predetermined positioning determination server which is connected to the mobile communication terminal via a network. For example, the mobile communication terminal may receive signals from a plurality of base stations, and transmit the received signals to the positioning determination server via a network. The positioning determination server may determine a location of the mobile communication terminal according to the methods illustrated in FIG. 3, 6, or 8. Here, information about the location of the mobile communication terminal, which is determined in the positioning determination server, may be fed back to the mobile communication terminal with location-based service information. Also, the positioning determination server may be installed in the base station, a base station control point, a base station exchanger, and the like. Specifically, as long as the location is capable of receiving a signal from the mobile communication terminal, an installation place of the positioning determination server is not limited.

However, when considering a significant improvement of a resource environment, such as a radio frequency (RF) module, a memory, and a processor of a mobile communication terminal, and the like, it is possible to enable the mobile communication terminal to directly determine the location of the mobile communication using base station identification information without help from the positioning determination server via the network, by installing and executing a configuration of a location determination system according to the present invention in the mobile communication terminal. Here, the base station identification information is received from each of the base stations. Specifically, when determining the location of the mobile communication terminal, it is possible to reduce a system load, which may occur due to a message between the mobile communication terminal and the positioning determination server, by not constructing a separate platform in the mobile communication terminal, but installing the location determination system in the mobile communication terminal. Also, it is possible to save on costs which may occur when constructing the separate platform. Thus, a mobile communication provider may quickly introduce and activate a location-based service (LBS).

While the above-described exemplary embodiments of the present invention takes an example of a pilot signal as a base station identification signal which is received from each base station, the present invention is not limited thereto. Thus, it will be apparent to those of ordinary skill in the related art that various types of signals may be utilized when a mobile communication terminal can identify each signal which is received from each of the base stations, and measure an RSS, i.e. power of each of the received signals.

The above-described methods correspond to a downstream method in which a mobile communication terminal or a predetermined positioning determination server measures the strength of signals, which are received from base stations, and determines a current location of the mobile communication terminal. Also, the above-described methods may be applicable to an uplink method. For example, as shown in FIG. 12, a plurality of base stations receives a base station identification signal from a mobile communication terminal. A predetermined positioning determination server may collect the base station identification signals, which are received in the base stations, via a network, and determine a location of the mobile communication terminal by using a distance ratio based on a strength difference between the signals according to the methods illustrated in FIG. 3, 6, or 8. Here, information about the location of the mobile communication terminal, which is determined in the positioning determination server, may be fed back to the mobile communication terminal with location-based service information.

A method and system for determining a location of a mobile communication terminal according to the present invention has been described above, based on a two-dimensional plane, but the present invention is not limited thereto. The present invention may be applicable to a three-dimensional space with a little modification to the above-described equations.

Also, a method and system for determining a location of a mobile communication terminal according to the present invention may be applicable to a mobile communication network, and to any type of wireless communication service, such as the Portable Internet (e.g., wireless broadband (WiBro)), and the like.

As described above, in a method and system for determining a location of a mobile communication terminal according to embodiments of the present invention, the location of the mobile communication terminal may be determined based on the distance ratios dₗ/dᵢ between the plurality of base stations and the mobile communication terminal. In this case, a weighted centroid method of multiplying the distance ratios dₗ/dᵢ and weights, and acquiring the mean of the results of the multiplications, a nonlinear optimizing method of utilizing an Apollonius circle, which uses the distance ratios dₗ/dᵢ as variables, or a method of selecting virtual base stations from which the mobile communication terminal does not receive a signal may be utilized.

The invention can also be embodied as computer-readable codes on a computer readable recording medium. The computer-readable recording medium is any data storage device that can store data which can be thereafter read by a computer system. Examples of the computer-readable recording medium include read-only memory (ROM), random-access memory (RAM), CD-ROMs, magnetic tapes, floppy disks, optical data storage devices, and carrier waves, such as data transmission through the Internet. The computer-readable recording medium can also be distributed over network coupled computer systems so that the computer-readable code is stored and executed in a distributed fashion.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

### INDUSTRIAL APPLICABILITY

As described above, according to the present invention, a method and system for determining a location of a mobile communication terminal utilizes distance ratios between a plurality of base stations and the mobile communication terminal. Thus, even when the strength of signals, which are received from the plurality of base stations, or distance values, which are calculated based on the strength, are greatly affected by a surrounding environment (shadowing effect), such as, indoor or a shadowing area, the location of the mobile communication terminal may be accurately determined due to a comparative stability of the distance ratios. Accordingly, the method and system for determining the location of the mobile communication terminal may be applicable to various types of wireless communication services with a comparatively small amount of costs.

1. A method of determining a location of a mobile communication terminal, the method comprising:
receiving base station identification signals from a plurality of base stations;
calculating distance ratios between the plurality of base stations and the mobile communication terminal, from the received base station identification signals;
generating first variables and second variables from the distance ratios; and
determining the location of the mobile communication terminal from the first variables and the second variables.

2. The method of claim 1, wherein each of the distance ratios designates a ratio which is acquired by comparing a distance between a particular base station and the mobile communication terminal with the distance between each of the plurality of base stations and the mobile communication terminal.

3. The method of claim 1, wherein the distance ratios are calculated based on a power difference between two base station identification signals which are received from the plurality of base stations.

4. The method of claim 1, wherein the first variables and the second variables correspond to centers and radiuses of an Apollonius circles respectively.

5. The method of claim 4, wherein the location of the mobile communication terminal corresponds to a location where a sum of squares of distances from the centers of the Apollonius circles to the location of the mobile communication terminal becomes a minimal value.

6. The method of claim 4, wherein the location of the mobile communication terminal is determined by,
$$X ( x , y ) = {arg min}_{X} {{Q}_{i = 1}}^{n - 1} \frac{( {\vert X - {O}_{i} \vert}^{2} - {P}_{i}^{2} )}{{P}_{i}^{2}}$$
where n designates a number of the base stations, X designates the location of the mobile communication terminal, O designates a center of the Apollonius circle, and P designates a radius of the Apollonius circle.

7. The method of claim 1, further comprising:
determining a center of the plurality of base stations from the received base station identification signals; and
extracting location values of virtual base stations from which a base station identification signal is not received within a predetermined radius from the determined center,
wherein the location values of the virtual base stations are utilized for determining the location of the mobile communication terminal.

8. The method of claim 7, wherein a location of a virtual base station, of which distance with the mobile communication terminal is greater than a threshold value, is reflected in determining the location of the mobile communication terminal, and a location of a virtual base station, of which distance with the mobile communication terminal is less than the threshold value, is not reflected in determining the location of the mobile communication terminal.

9. The method of claim 7, wherein:
the first variables and the second variables correspond to centers and radiuses of an Apollonius circles respectively, and
the location of the mobile communication terminal is determined by,
$$X ( x , y ) = {arg min}_{X} \{ \begin{matrix}{{Q}_{i = 1}}^{n - 1} \frac{( {\vert X - {O}_{i} \vert}^{2} - {P}_{i}^{2} )}{{P}_{i}^{2}} + \\ {{Q}_{j = 1}}^{m} \frac{SCALE}{( 1 + exp ( \vert X - {V}_{j} \vert - {D}_{th} ) )}\end{matrix} \}$$
where n designates a number of the base stations, m designates a number of the virtual base stations, X designates the location of the mobile communication terminal, O designates a center of the Apollonius circle, P designates a radius of the Apollonius circle, SCALE designates a coefficient, V designates a location of a virtual base station, and D designates a threshold value.

10. A method of determining a location of a mobile communication terminal, the method comprising:
receiving base station identification signals from a plurality of base stations;
calculating weights based on a distance between each of the plurality of base stations and the mobile communication terminal, from the received base station identification signals; and
determining the location of the mobile communication terminal from the weights and location values of the plurality of base stations.

11. The method of claim 10, wherein each of the weights is an inverse of the distance between each of the plurality of base stations and the mobile communication terminal.

12. The method of claim 10, wherein each of the weights designates a ratio which is acquired by comparing a distance between a particular base station and the mobile communication terminal with the distance between each of the plurality of base stations and the mobile communication terminal.

13. The method of claim 10, wherein the mean of location values of the plurality of base stations based on the weights is determined as the location of the mobile communication terminal.

14. A system for determining a location of a mobile communication terminal, the system comprising:
a distance ratio calculation unit calculating distance ratios between a plurality of base stations and the mobile communication terminal, from base station identification signals which are received from the plurality of base stations;
a locus calculation unit generating first variables and second variables from the distance ratios; and
a location determination unit determining the location of the mobile communication terminal from the first variables and the second variables.

15. The system of claim 14, further comprising:
a virtual base station selection unit determining a center of the plurality of base stations from the received base station identification signals, and extracting location values of virtual base stations from which a base station identification signal is not received within a predetermined radius from the determined center,
wherein the location determination unit utilizes the location values of the virtual base stations for determining the location of the mobile communication terminal.

16. A system for determining a location of a mobile communication terminal, the system comprising:
a weight calculation unit calculating weights based on a distance between each of a plurality of base stations and the mobile communication terminal, from base station identification signals which are received from the plurality of base stations; and
a location determination unit determining the location of the mobile communication terminal from the weights and locations values of the plurality of base stations.

17. A computer-readable recording medium storing a program for implementing the method according to claim 1.
